(19) United States
(12) Patent Application Publication
(10) Pub. No.: US 2005/0287301 A1
(43) Pub. Date: Dec. 29, 2005

(54) Method for decorative finishing of metal surfaces

(76) Inventor: Andrei V. Ljubomirsky, Vilenovich (RU)

Correspondence Address: Ilya Zborovsky, 6 Schoolhouse Way, Dix Hills, NY, 11746, US

(21) Appl. No.: 10/532,466

(22) PCT Filed: Oct. 20, 2003
(86) PCT No.: PCT/RU03/00442

§ 371 Date: Apr. 23, 2005

(30) Foreign Application Priority Data
Oct. 23, 2002 (RU) 2002128363

(51) Int. Cl. B05D 5/00; B05D 3/02

(52) U.S. Cl. 427/256; 427/372.2

(57) ABSTRACT

The inventive method for decorative finishing of metal surfaces consists in forming a decorative relief having a predetermined profile on a metal surface, applying a paint film to the totality of the decorated metal surface, carrying out a mechanical removal of said paint from the metal surface areas bearing the original profile, hardening the paint film contained in the volume of the elements of the decorative relief and in returning the excessive paint removed from the metal surface for the reuse thereof.

The invention pertains to the technique of decorative treatment of surface of the metal products, mainly in the form of sheet materials.

The known at the technical level method of decorative treatment of metals includes work-piece surface preparation, selection of sectors, corresponding to the shades of the multicolored pattern, the background application and graphical reproduction of the pattern by means of making the grooves with further colorless transparent varnish covering, thereat the background application is effected by means of stage-by-stage patination with reproduction at each of the stages of the background, corresponding to one shade of the pattern, with simultaneous maintenance of the patination regimes at each of the stages, securing the given shade attainment, and after the graphical pattern is reproduced, the additional similar patination of sectors with the grooves is effected (inventor's certificate SU-A-No. 1158388).

The known method secures the attainment of high quality decorative patterns on metal articles (colored pictures and souvenirs). However, due to a high degree of labor-intensiveness the known method cannot be used for the industrial (large-series) production of metal facing materials due to the high cost of the ready-made goods. Thus, the known method has a very limited sphere of application, which appears to be its basic drawback.

Another method of decorative treatment of metals is known to be taken as a prototype, which includes formation on the metal surface with initially pre-determined profile of the decorative relief by means of local plastic deformation of metal surface, with further covering of all the metal decorative surface with a paint layer, which is getting hard later (patent U.S. Pat. No. 3,764,067, 1973).

The drawback of the known method consists in its lack to secure the high quality decorative pattern attainment, since the decorative relief elements and the remaining part of metal (the background) are colored with the same paint.

The present invention is aimed at the solution of the technical task of safeguarding the high quality decorative patterns attainment with simultaneous retention of high efficiency in the process of decorative articles manufacture and considerable reduction of paint consumption.

The task put by has been solved in the following way: In adherence with the invention, when method of decorative treatment of metal is applied—which comprises formation of decorative relief on the surface of metal with the predetermined initial profile, application of the paint layer to the whole decorative surface of metal, as well as performance of the operation, securing paint hardening—the paint, applied to the metal surface with initial profile, is totally mechanically removed before the operation, securing paint hardening, is conducted, and the excess paint is directed for the repeated usage.

Besides, the set task has been solved, as below:
the decorative relief is formed by means of mechanical plastic deformation of the metal surface sectors;
the decorative relief if formed by means of local action of at least one chemical substance, being the etch for the treated metal, onto its surface;
the decorative relief is formed by means of the local action of the heavy laser emission onto the metal surface;
decorative relief is formed in the form of grooves and/or cavities, which depth is less, than the thickness of the treated metal;
grooves and/or cavities are made with the locking elements;
the liquid paint is applied to the whole metal decorative surface, the paint hardening is safeguarded by thermal drying;
the powder paint is applied to the whole metal decorative surface, powder paint hardening is safeguarded by means of the work-piece thermal treatment at the temperature of the paint sintering;
the powder paint layer is exposed to compaction in the direction, perpendicular to the treated metal surface;
powder layer compaction is conducted simultaneously with the removal of paint, applied to the metal surface sectors having the initial profile;
a layer of the powder material, dissolved in the adhesive solution, is applied to the whole metal decorative surface;
the thickness of the applied paint layer does not exceed the maximum depth of the decorative relief elements;
the paint layer, applied to the metal surface sectors with initial relief, is removed with the help of the scraper;
for excessive paint removal a scraper, equipped with the pneumatic conveyor is used.

The advantage of the suggested method of decorative treatment of metals over the known one (taken as a prototype) consists in the following: this method provides for retention of the high output level of the goods production along with safeguarding the essential quality improvement of the obtained decorative patterns, since only the elements of the decorative relief are painted. Due to the introduction of the operation of the total removal of the non-hardened paint from the metal surface sectors with the initial relief (in other words from the metal surface sectors, located between the decorative relief elements), a substantial reduction of paint consumption is secured, since the removed paint is directed for the repeated usage. It is necessary to note here, that in principle, it would be possible to secure quality improvement of the decorative patterns (obtained by the prototype method) by means of mechanical removal of the hardened paint form the metal surface sectors, located between the decorative relief elements. However, introduction of this additional operation would lead not only to extra (rather substantial) expenditures, connected with removal of the hardened paint, but also would result in the failure of the integrity of paint, filling in the volume of the decorative relief elements, due to the exposure of the paint to operation with grinding tools. In other words it would result not only in unpractical paint waste, but also in durability reduction of the obtained goods, since due to mechanical failures of the hardened paint the probability of its fall out of the decorative relief elements is increasing.

Removal of the excessive non-hardened paint with the help of the mechanical media is optimal from the point of view of securing the good filling with paint of the volume of the decorative relief elements, flush with the surface sectors of the initial relief.

The decorative relief formation by means of the mechanical plastic deformation of the metal surface sectors allows to use the widely spread equipment for metal treatment under pressure, which additionally permits to reduce the cost of the ready-made goods.

Formation of the decorative relief with application of the metal surface local etching allows to obtain the decorative relief of practically any shape.

Usage of laser manufacturing equipment allows to reach high precision in the decorative pattern reproduction.

Decorative relief (its' elements) formation in the form of grooves and/or cavities with depth, less, than the treated material, permits to simplify the implementation of the method.

The advantage of usage of the powder (dry) paint as compared to the liquid one or the paint, obtained by means of dissolving the powder painting material in the adhesive solution, consists in performance of its hardening only after the treated work-piece has been delivered into the sintering chamber.

It is advisable (in the course of method implementation) to use liquid paints, which hardening is provided by means of thermal drying instead of hardening under standard conditions, since usage of such paints simplifies the process of their repeated usage.

The invention is further explained with the help of the drawings and their explication.

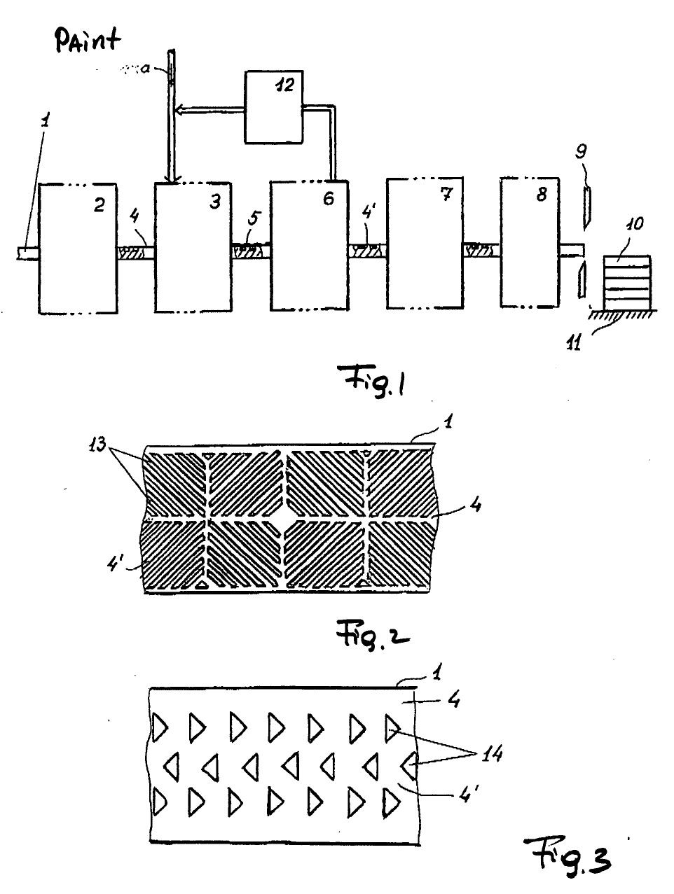

FIG. 1 depicts the scheme of the processing line for the implementation of the metal decorative treatment;

FIG. 2—shows a variant of the decorative relief execution on the metal band surface (top view);

FIG. 3—another variant of the decorative relief execution on the metal band surface (top view);

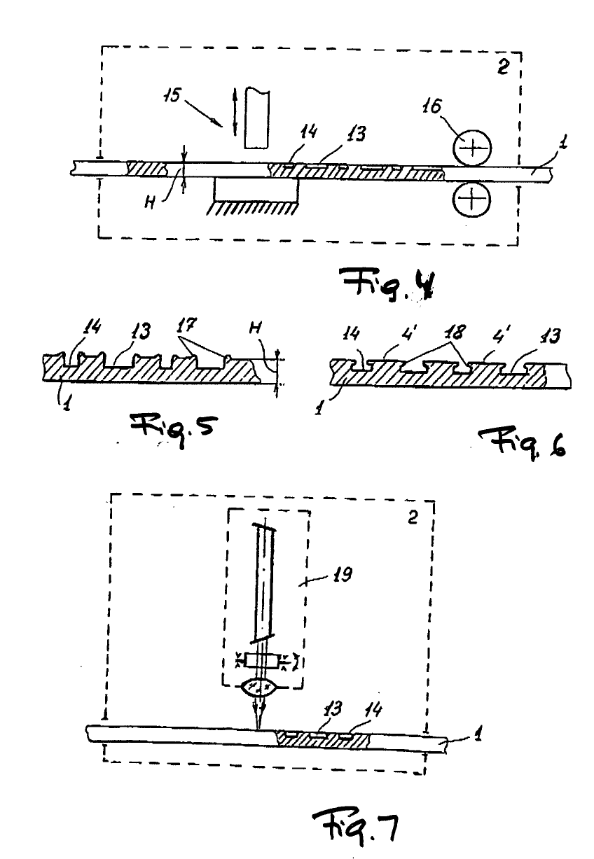

FIG. 4—the plant for the decorative relief formation on the metal band surface;

FIG. 5—a fragment of the metal band after decorative relief formation by means of impact molding (longitudinal section);

FIG. 6—the same after the operation of smoothing the decorative irregularities;

FIG. 7 the plant for formation on the metal band surface of decorative relief with application of laser equipment;

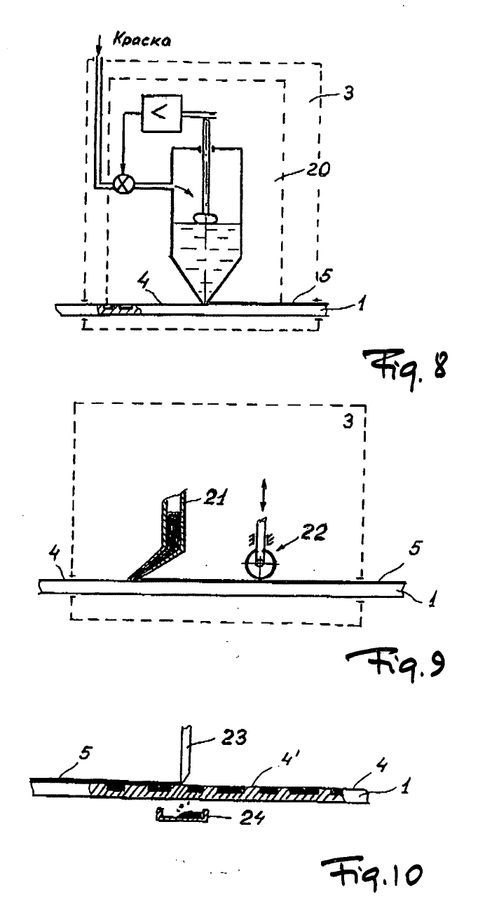

FIG. 8—the plant for coating the whole decorative metal band surface with a paint layer;

FIG. 9—the same for powder paint application;

FIG. 10—the device for total mechanical paint removal from the sectors of metal band surface with initial profile;

FIG. 11—the same for the case of powder paint usage;

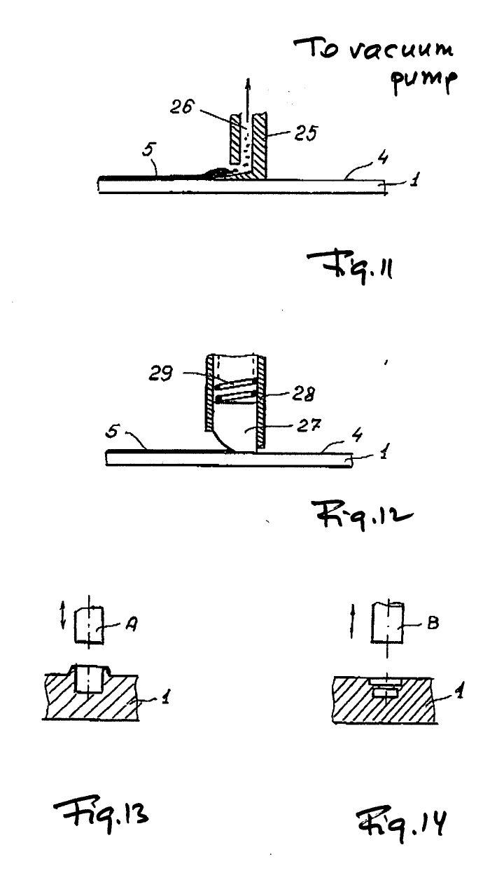

FIG. 12—the variant of execution of means for powder paint layer compaction, that simultaneously secure total mechanical paint removal from the metal hand segments with initial profile;

FIG. 13—a metal band fragment after formation in it of the decorative relief element by means of mechanical plastic deformation;

FIG. 14—the same after the calibration operation of the decorative relief element with the big size tools of the same shape with tools, used for decorative relief element formation.

The manufacturing line (FIG. 1) for execution of the decorative metal treatment method comprises the sequentially located along the metal band traverse direction 1: a plant 2 for formation on the metal band surface 1 with predetermined initial profile (predominantly linear) of the decorative relief, the plant 3 for coating of the whole metal band 1 decorative surface 4 with a paint layer 5, the device 6 for total mechanical paint removal from sectors 4 of metal band 1 surface with initial profile, media 7, securing paint hardening (the chamber, that secures adequate conditions for paint drying, polymerization and sintering depending on the type of paint used), device 8 for polishing of metal band 1 surface 4 sectors 4 with initial profile, the device 9 for metal band 1 cutting into sheets 10 of finite length and the section 11 of sheet 10 stacking and packaging in piles. Besides that, the manufacturing line also contains the media 12 for the return of the excessive paint from the device 6 for total mechanical paint removal from sectors 4 of the metal band surface 1 with initial profile, back to plant 3 for coating the whole metal band 1 decorative surface 4 with a paint layer 5.

A plant 2 for formation on the metal band surface 1 with predetermined initial profile of the decorative relief can be executed using the equipment for mechanical metal treatment under pressure, i.e.: rolling-mill equipment or presses.

The preferable variant of execution of the decorative metal treatment method consists in relief formation by means of creating on the metal band 1 surface 4 of grooves (flutings) 13 (FIG. 2) or cavities (hollows) 14 (FIG. 3). As an elementary case (FIG. 4), formation being done on the surface of the metal bands with predetermined, for instance linear, profile the plant 2 for decorative relief formation in the form of grooves 13 and cavities 14 with depth less than thickness-H of the metal band 1, represents a press 15 and a device 16 for smoothing the surface 4 irregularities 17, formed in the punching process (FIG. 15), with creation of locking elements 18 (FIG. 6), as well as for recovery of the initial profile of metal band 1 surface 4 sectors 4 (calibration) located between elements 13 and/or 14 of the decorative relief.

The decorative relief elements (grooves 13) can be also formed by the local removal of the metal band 1 surface 4 material 6, for instance by means of mechanical application of flutes, cuts. The laser scribing device 19 (FIG. 7), permitting to create not only grooves 13, but also cavities 14 both of rectangular and trapezoidal section, is applied in the preferable variants of execution of the decorative metal treatment method. In cases, when metal sheets of finite length are used instead of metal band 1, a method of local chemical etching can be used for decorative relief formation on their surface. Thereat a widely spread in the semiconductor technology method of photolithography can be applied for protecting mask formation. Photolithography method (see. Physical Encyclopedia, M, iss. by S. P. “Big Russian Encyclopedia”. 1998, v. 5, p. 350) Includes coating of the work-piece surface with a layer of photosensitive material, for instance, photo resist, writing (photo replication) and material removal of the photosensitive layer from not exposed sectors.

The constructive execution of the plant 3 for coating of the whole metal band 1 decorative surface 4 with a paint layer 5, depends on the type of the paint used: liquid paints (obtained by using various solvents), pains on the basis of powder materials, dissolved in adhesive substances, dry powder (grain) painting material. When liquid paints or paints on the basis of the adhesive solutions are used, the plant 3 for coating of the whole metal band 1 decorative surface 4 with a paint layer 5 can be executed as the paint carrying device, which is as well in contact with surface 4 of the whole metal band 1 width (brushes, pads, rollers). Also the paint carrying devices 20, with the lower slit channel, securing coating by means of the liquid gravity flow, can be used. Usage of the spraying devices for liquid paint spraying onto the moving surfaces is possible as well.

When the dry powder (grain) painting materials are used, the plant 3 for coating of the whole metal band 1 decorative surface 4 with a paint layer 5, but for the device 21 for coating the metal band 1 surface 4 with powder, contains as well media 22 for compaction (ramming) of the powder paint layer 5 in the direction, perpendicular to the metal band 1 surface 4 (FIG. 9).

The device 6 for total mechanical paint removal from sectors 4 of metal band 1 surface with initial profile, in the elementary case is executed in the form of a scraper 23, which shape in the cross direction of the metal band 1 coincides with its initial profile (FIG. 10). Below the meal band 1, the media for excessive paint collection (for instance tray 24) are placed, the excessive paint is returned back into the plant 3 (FIG. 1) with the help of respective pump (is not shown in the drawing). When the powder paint is used, the scraper 25 is executed jointly with pneumatic conveyor 26 for collection and return of the excessive powder paint back to the plant 3 (FIG. 11) through a cyclone (is not shown in the drawing).

FIG. 12 shows the variant of execution of media for powder paint layer compaction, which simultaneously secure total mechanical removal of paint, covering surface 4 sectors 4 of the metal band 1 with initial profile. Element 27 from the elastodeformed material is located so as to provide the possibility of its vertical traverse within the housing 28 and is spring loaded relative to the metal band 1 with spring 29. It is necessary to note here, that at the same time its excessive paint is removed (flush) from the surface sectors, corresponding to the decorative relief elements.

Media 7, that secures paint hardening depending on the type of paint used, are executed, for instance, in the form of a drying chamber, where the temperature regime is maintained either by means of non-contact heating sources (thermal high frequency, infrared beaters) or with the help of contact beaters (one-sided or double-sided heating). When the powder paint is used, media 7 are also executed in the form of a chamber, but the temperature regime there should secure powder paint particles sintering. When the self-hardening at the normal temperature based on adhesive paints is applied, usage of the chamber is caused only by the necessity to protect the metal band 1 surface 4 from various contaminations.

Device 8 for polishing is used taking into account the specific parameters put forward in respect of the ready products. In the given case any polishing devices, which technical and operational parameters meet the requirements of each special case, can be used.

Method of decorative treatment of metals is executed in the following way. The metal band 1 is moved in the horizontal direction with the help of, for instance, the guiding rollers, used in the rolling-mill equipment. With the help of the plant 2 the formation of the decorative relief on the surface 4 of the metal band 1 with predetermined initial profile is effected. However the metal band 1 profile can also be curvilinear, corresponding to the cylindrical surface sector, thereat the metal band 1 surface 4 can be both convex and concave, that is often required for decoration of the inner walls of rooms, in particular pools' bowls. In the preferable variant of execution of the method, the decorative relief is formed either in the form of grooves (hollows, flutings) 13, or cavities of various shapes, or simultaneously in the form of grooves 13 and cavities 14 (FIGS. 3, 4 and 5), thereby the depth of grooves 13 and cavities 14 being less than thickness-H of the metal band 1. In order to avoid the failing out of the hardened paint from the grooves 13 and cavities 14, they are executed, for instance, with locking elements 18 (FIG. 6).

The decorative relief is formed by means of mechanical plastic deformation of the metal band 1 surface 4 sectors with the help of, for example, one press 15 (FIG. 4). However, for formation of a complicated decorative relief the plant 2 may contain several presses, located in series. The plant 2 comprises, if necessary, means for metal band 1 heating before each or only before a specific pressing operation. After pressing operation, the operation of smoothing the metal band 1 surface 4 irregularities 17 is effected, the irregularities are formed as the result of the mechanical plastic deformation with application of the device 16. In this case the operation of irregularities 17 smoothing allows to form simultaneously the locking elements 18 (FIGS. 5 and 6), preventing the fall out of the decorative relief elements (in particular the grooves 13 and the cavities 14). However, in a number of cases it is expedient to conduct independently the operations of locking elements formation, for example, by means of calibration of each decorative relief element with big size tools—B of the same shape, as tools—A, used for formation of the given decorative relief element (FIGS. 13 and 14). (Besides methods of creating the locking elements) for elimination of possibilities for fallout of hardened paint from the decorative relief elements, the methods, improving paint adhesion to the metal band 1 material can also be used. The stamping regimes are chosen, basing on the known properties of the applied metal band 1, in accordance with the standard and used technique in the technical field, pertaining to metal treatment under pressure.

Decorative relief elements (grooves 13 and cavities 14) can be formed by means of plant 2, implemented on the basis of laser manufacturing equipment particular device 19 (FIG. 7), including located in series: the source of powerful laser radiation, the scanning element (in the direction, perpendicular to the drawing surface, in other words crosswise the metal band 1) and the focusing element (cylindrical lens). The source of powerful laser radiation and the scanning element are connected to terminals of the control unit (not shown), providing for the local impulse exposure of the metal hand 1 surface 4 to the powerful laser radiation in accordance with the decorative relief to be formed. In this case it is possible to obtain the decorative elements not only of rectangular, but also of trapezoidal section (FIG. 7). Execution of decorative elements with trapezoidal profile prevents hardened paint fallout from them, which enhances the durability of the decorative pattern. Removal of a part of the metal band 1 material in the course of its' surface exposure to the powerful laser radiation occurs due to boiling up and upwards injection of the molten material form the surface 4 local sector.

The decorative relief elements can be formed on metal sheets of finite length by using the chemical etching for metal sheet materials. In that case the metal sheet surface is covered with the protection coating, on which by means of, for instance, application of a photolithography method, windows are created in the places of the future decorative relief elements. After that the non protected metal sheet surface spaces are exposed to etching (one of the chemical substances mixtures, serving to be the etch for the given material). Metal (in non protected spaces) is dissolved under the action of the etch (etches), grooves and cavities, replicating the windows shape of the protective coating, being formed on its surface as the result. The protective coating is removed from the metal sheet afterwards, and the metal sheet is delivered to the plant 3 for coating the decorative surface with a paint layer 5.

After formation of the decorative relief on the surface of the metal band 1 with the predetermined initial profile, the whole metal band 1 decorative surface 4 is covered with a paint layer 5. Thereat the liquid paints, based on various solvents, pasta-like paints, based on adhesives, as well as dry powder paints can be used. The choice of paint mainly depends on the initial metal band profile. Application of liquid and paste-like paints is effected, for instance, with the help of the device 20 (FIG. 8). The paint is placed into the vessel, having in its bottom part the outlet slit channel, through which the liquid is carried by gravity flow to the metal band surface 4. The liquid paint level detector and the control valve secure maintenance of the set paint level in the vessel. Consequently the constant thickness of the applied paint layer 5 is secured the thickness of paint layer 5 should not exceed the maximum depth of decorative relief elements (grooves 13 and/or cavities 14). The optimal thickness of paint layer 5 should make 0,5-0,9 of the maximum depth of the decorative relief elements. Should the thickness of the paint layer 5 be less, than the bottom limit, the full filling of the decorative relief elements is not secured. Should the thickness of the paint layer 5 be more, than the upper limit, the paint excessive quantity is increased, therefore the method economy is decreased. The above is valid both for the paints, based on powders, dissolved in adhesive solution (paste-like paints), and for the dry powder paints.

Device 20 can be used also for coating the surface 4 with paste-like paints. As it has been already note above, different devices can be used for liquid paint application, including spraying devices. The choices of one or another device for application of the paint layer 5 out of the known devices is determined by the specific requirements, put forward in respect of the ready-made goods, in other words, these characteristics do not refer to the number of the essential characteristics from the point of view of the expected technical result acquisition.

The device, shown in FIG. 9 can be used when the powder dry paints are applied. The paint from the container 21 is coming to the metal band surface 4 from the bottom slot. After that compaction of the powder paint layer 5 is effected in the direction, perpendicular to the metal band 1 surface 4 by means of device 22, executed in the form of a ramming element of elastodeformed material, vibrating in the vertical direction, for instance, rubber. As a result the execution of the decorative relief elements is improved.

After that the total removal of non-hardened paint from the metal band 1 surface 4 sectors 4 with initial profile (in other words form the surface sectors, located between the decorative relief elements) is performed. For that the scrapers of different design are used. In particular a scraper 23, shown in FIG. 10, can be used, its shape in the direction, perpendicular to the drawing surface repeats the metal band 1 surface 4 profile. The excessive paint is flowing (In case of liquid paint) along the metal band edges into the tray 24, where from by means of a pump (not shown) is delivered back into the plant 3 for repeated usage. FIG. 1 shows the variant of the paint return into the line for paint feeding to the plant 3.

For removal of the powder paint excesses it is expedient to apply the scraper 25, shown in FIG. 11 and equipped with pneumatic conveyor 26. The excessive paint quantity is supplied by air flow along the pneumatic conveyor to a cyclone (not shown in the drawing), where its separation is performed. After that the separated powder paint is returned into plant 3.

It is expedient to use the device, shown in FIG. 12, as means for powder paint layer compaction. Element 27 from the elastodeformed material is pressed to metal band 1 surface 4 by spring 29. As a result the powder paint is pressed into the decorative relief elements (fills in their volume) on the one hand, and on the other hand the powder paint is removed from elements 4 of the surface 4 (i.e. for the surface 4 spaces, located between the decorative relief elements). In other words the device, shown in FIG. 12 secures execution of two operations under the given method, namely: operation of powder paint layer compaction and operation of its removal from the metal band 1 surface spaces with initial profile.

Depending on the paint layer 5 thickness, as a result of the operation, described above, the excessive quantity of paint from the metal band 1 surface spaces, corresponding to the decorative relief elements, are simultaneously removed. Consequently, the non-hardened paint at the spaces of surface 4, corresponding to the decorative relief, is flush located with respect to sectors 4. Further on the operation, securing hardening of paint, filling in the decorative relief elements, is performed. With application of means 7 either thermal drying of liquid paint, or sintering at appropriate temperature of the powder paint, or the self-hardening of the paint powder, dissolved in the adhesive solution (polymerization) is performed. Thereby the regime parameters in accordance with the recommendations of the paint manufacturer, whose paint is used for execution of the suggested method of metal decorative treatment, are applied.

After that (in case of necessity for securing the required characteristics of the ready-made product) polishing of the metal band 1 surface 4 sectors 4, cutting of metal bands 1 into the sheets 10 of the required finite length, with further sheets 10 stacking and packing in sector 11, are performed.

The suggested method of the decorative treatment of metals can be used in industry for acquisition of decorative patterns on facing metal sheets, of stainless steel predominantly. The method permits to secure manufacture of high quality facing metal sheets with high productivity, thereat it is required to observe only the known technological parameters, predetermined by the properties of the applied metal and paint.

1. Method of decorative treatment of metals, including formation on the surface of metal with the predetermined initial profile of the decorative relief, coating of the whole decorative metal surface with a paint layer, as well as performance of the operation, securing paint hardening, which distinguishing feature is, that before the operation, securing paint hardening is performed, the total removal of paint, applied to the metal surface spaces with initial profile is effected, and the excessive quantity of paint is directed to the repeated usage.

2. Method as per item 1, that differs by decorative relief formation by means of plastic deformation of the metal surface sectors.

3. Method as per item 1, that differs by decorative relief formation by means of local exposure of the treated metal surface to at least one chemical substance, being the etch for the treated metal.

4. Method as per item 1, that differs by decorative relief formation by means of local exposure of the treated metal surface to the powerful laser radiation.

5. Method as per item 1, or item 2 or item 3 or item 4. Method as per item 1, that differs by decorative relief formation in the form of grooves or/and cavities with depth less, that the treated metal thickness.

6. Method as per item 5, that differs by execution of the grooves and/or cavities with locking elements.

7. Method as per item 1, that differs by covering of the whole metal decorative surface with a layer of liquid paint, which hardening is secured with thermal drying.

8. Method as per Item 1, that differs by covering of the whole metal decorative surface with a layer of powder paint, which hardening is secured with thermal treatment of the work-piece at the temperature of paint sintering.

9. Method as per item 1, that differs by effecting compaction of the powder paint layer in the direction, perpendicular to the treated metal surface.

10. Method as per item 9, that differs by performance of powder paint layer compaction simultaneously with removal of paint, applied to the metal surface with the initial profile.

11. Method as per item 1, that differs by covering of the whole decorative metal surface with a layer of powder material, dissolved in the adhesive solution.

12. Method as per item 1, or item 7 or item 8 or item 11, that differs by covering with the paint layer, not exceeding the maximum width of the decorative relief elements.

13. Method as per item 1, or item 7 or item 8 or item 11, that differs by removal of the paint layer, applied to the metal surface sectors with initial profile, with the help of a scraper.

14. Method as per item 13, that differs by usage of a scraper, equipped with pneumatic conveyor for excessive paint removal.
